(19) United States
(12) Patent Application Publication
(10) Pub. No.: US 2008/0043974 A1
(43) Pub. Date: Feb. 21, 2008

(54) Communication system for selectively establishing communication among various types of communication devices

(76) Inventor: Scanner Chen, Xizhi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/485,997

(22) Filed: Jul. 14, 2006

(51) Int. Cl. H04M 7/00

(52) U.S. Cl. 379/219

(57) ABSTRACT

Disclosed is a communication system for selectively establishing a communication among various types of communication devices, including a communication line, at least one phone set connected to a Public Switched Telephone Network, a plurality of coupling devices of various types connected to the communication line, and a plurality of network-based communication devices of various types connected to the communication line and the Internet, wherein the network-based communication devices are IAD, VoIP and PC phone modules, the coupling devices are IAD integrating devices and VoIP gateways and the coupling devices includes an ADSL transmission device. The communication signals are coupled from the phone set to the network-based communication devices through the coupling devices to selectively establish a communication among the phone set and the network-based communication devices of various types.

### FIELD OF THE INVENTION

The present invention is in the general field of the communication system for communicating communication devices, and more specifically in the field of the communication system for selectively establishing a communication among various types of network-based communication devices.

### BACKGROUND OF THE INVENTION

With the prospering development of communication technologies, people are capable of communicating with others through various communication devices such as wired communication network, wireless communication network and the Internet. In addition to the convention cable telephone network such as the Public Switched Telephone Network, the network-based communication devices such as the Internet phones and PC phones (computer phones) can also be utilized to establish a communication.

### SUMMARY OF THE INVENTION

Although network-based communication devices (such as Internet phone modules and PC phone modules) offer people a brand new and a low cost way to establish a communication, to configure a plurality of network-based communication devices is of many drawbacks and problems:

1. The communication devices of the network-based communication devices can be categorized into two types, one of which is the earphones and the microphones as shown in FIG. 1, wherein the earphone and the microphone or a combination 11 is connected to the Internet 2 through a computer 12 and an ADSL modem 13. The other type is the USB phones as shown in FIG. 2, wherein a USB phone 14 is connected to the Internet 2 through the computer 12 and the ADSL modem 13. Not only either type is operable only with a computer, but also unable to be connected in the form of the conventional cable telephone network, which every phone set 15 in the connection is able to access public communication network through the PSTN 34 and the PSTN switching device 35 as shown in FIG. 5.

2. While using PC phones as shown in FIG. 1 and FIG. 2, users are very likely to miss incoming calls when they are not beside their PC phones. On the contrary, every phone set paralleled connected to the communication network of the PSTN generates rings to alert users about the incoming calls, hence lowering the possibilities of missing incoming calls.

3. The configuring of the IAD 16 as shown in FIG. 3 is the connection of phone set 15 to the Internet 2 by the IAD 16, which includes a VoIP TA and an ADSL modem, while the configuring of the VoIP gateway as shown in FIG. 4 is the connection of phone set 15 to the Internet 2 by the VoIP gateway 17 and the ADSL modem 13. Adapting the ways above requires a repeatedly configured network, which results in a plurality of communication devices each with a various function co-exist in a same place.

4. Although the terminal communication devices in both IAD and VoIP gateway PC phone systems are traditional phone sets and the functions of both IAD and VoIP gateway systems simulate that of the traditional communication networks, which are the providing of a direct current to the phone set, the ringing, the line detecting and the dial receiving, they are still unable to utilize a same communication line to make a connection to a same phone set due to the direct currents provided to the phone sets independently. In other words, connecting a phone set to two communication lines not only fails to establish a communication, but also causes a paralyzation.

In consideration of the above problems, the primary object of the present invention, therefore, is to provide a communication system for selectively communicating a plurality of communication devices, wherein the system integrates and co-exists cable telephone networks, network-based communication devices, PC phone systems and the PSTN by one single communication line and phone set.

Another object of the present invention is to enable a plurality of communication devices of various types to utilize one single communication line and one single phone set.

FIG. 2 is a perspective view of a low speed wind tunnel having a movable boundary in accordance with the present invention;

To realize the above objects, the present invention installs a communication system including a communication line for transmitting communication signals, at least one phone set connected to a Public Switched Telephone Network and a PSTN switching device through the communication line, a plurality of coupling devices of various types connected to the communication line and a plurality of network-based communication devices of various types connected to the communication line through the coupling devices peculiar to the communication devices and connected to the Internet through a plurality of network transmission device peculiar to the communication devices.

The communication signals are coupled from the phone set to the network-based communication devices through the coupling devices to selectively establish a communication among the phone set and the network-based communication devices of various types.

The communication system may further include an integrated box, and the composing elements of the communication system are made up in an integrated box. In addition, the composing elements of the communication system may be also integrated in one of the traditional phone set, the wireless phone set, the computer sound effect module, the ADSL transmission device, the IAD integrating device and the VoIP gateway.

In comparison with conventional technologies, the users of the present invention are able to communicate with traditional telephone network, Network-based communication devices and PC phones with conventional phone sets through one communication line.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional terminal communication device of a first type used in a conventional PC phone module configuration;

FIG. 2 shows a conventional terminal communication device of a second type used in a conventional PC phone module configuration;

FIG. 3 shows a conventional IAD configuration;

FIG. 4 shows a conventional VoIP gateway configuration;

FIG. 5 shows a conventional Public Switched Telephone Network configuration;

FIG. 6 is a block diagram of the connection between communication devices in accordance with the preferred embodiment of the present invention;

FIG. 7 shows the circuits of equivalent wiring between communication devices in accordance with the preferred embodiment of the present invention;

FIG. 8 is a block diagram of a conventional phone set shown in FIG. 6;

FIG. 9 is a block diagram of an IAD/VoIP phone module shown in FIG. 6;

FIG. 10 is a block diagram of a PC phone module shown in FIG. 6;

FIG. 11 is a block diagram of the conventional phone set shown in FIG. 6 for description;

FIG. 12 is a block diagram of an IAD/VoIP phone module shown in FIG. 6 for description; and

FIG. 13 is a block diagram of a PC phone module shown in FIG. 6 for description.

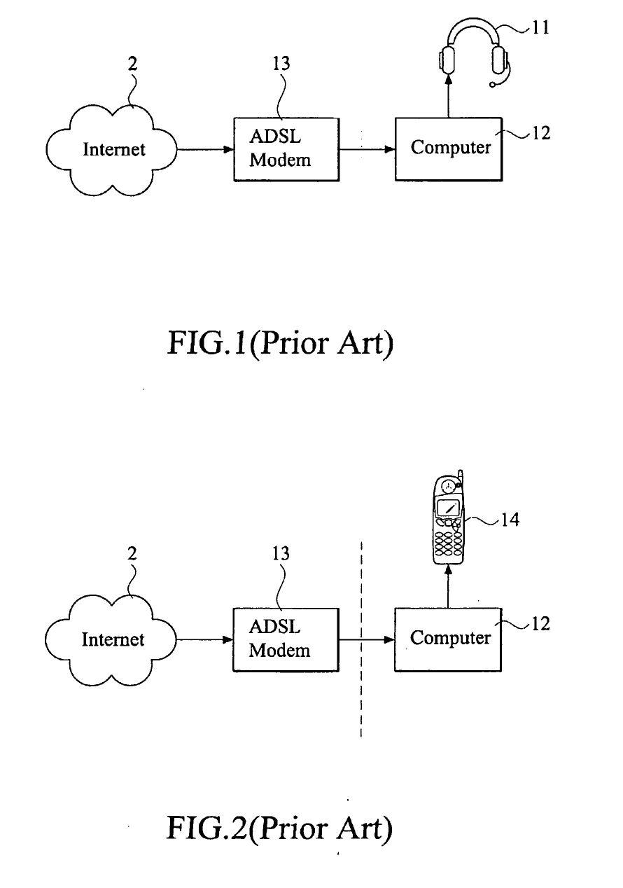

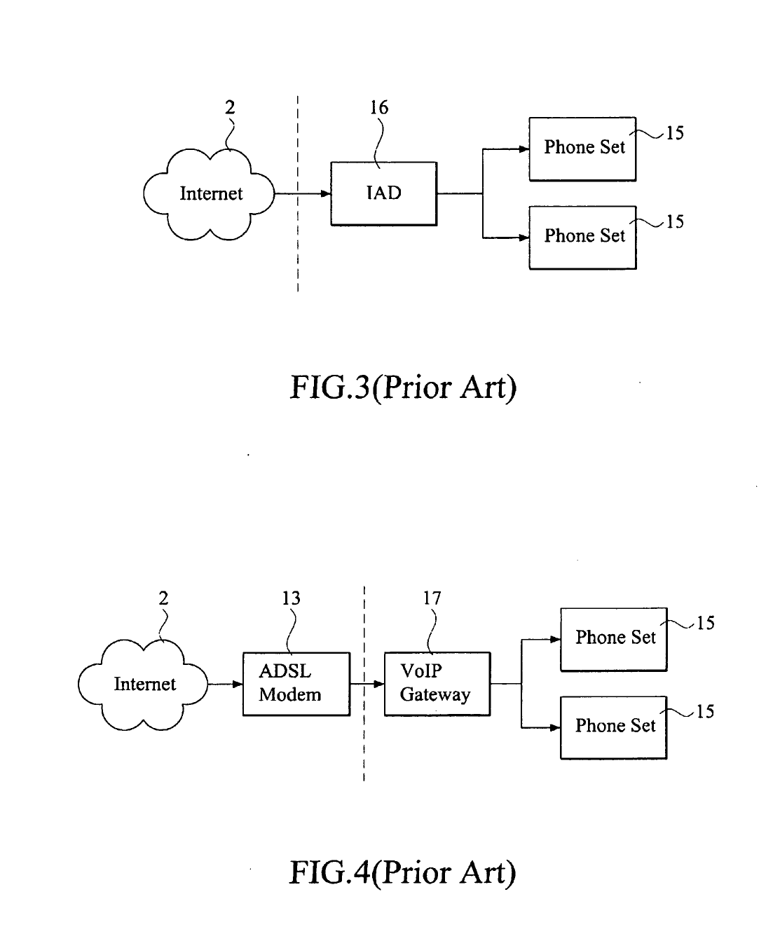

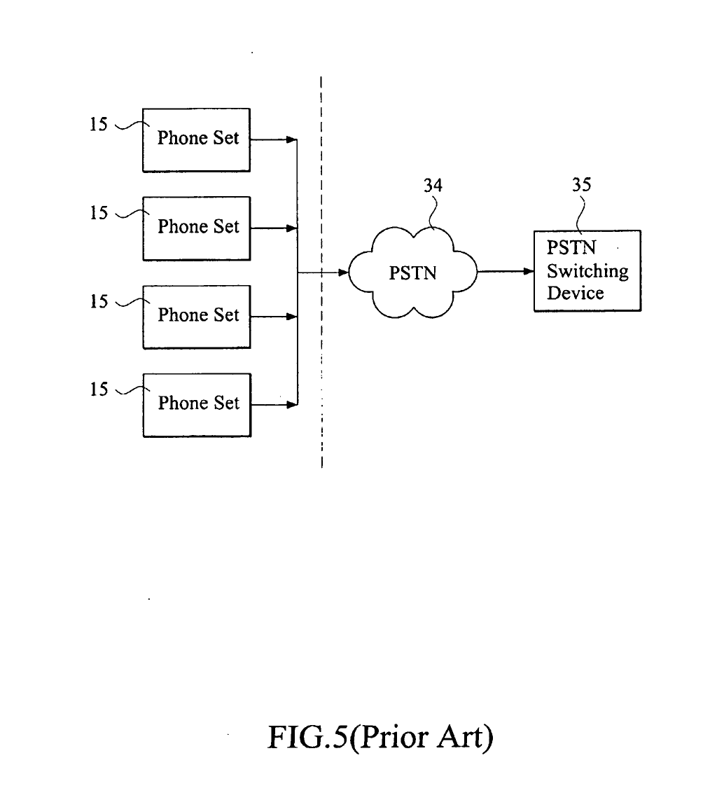

### DETAILED DESCRIPTION OF THE PREFERRED EMBODIMENTS

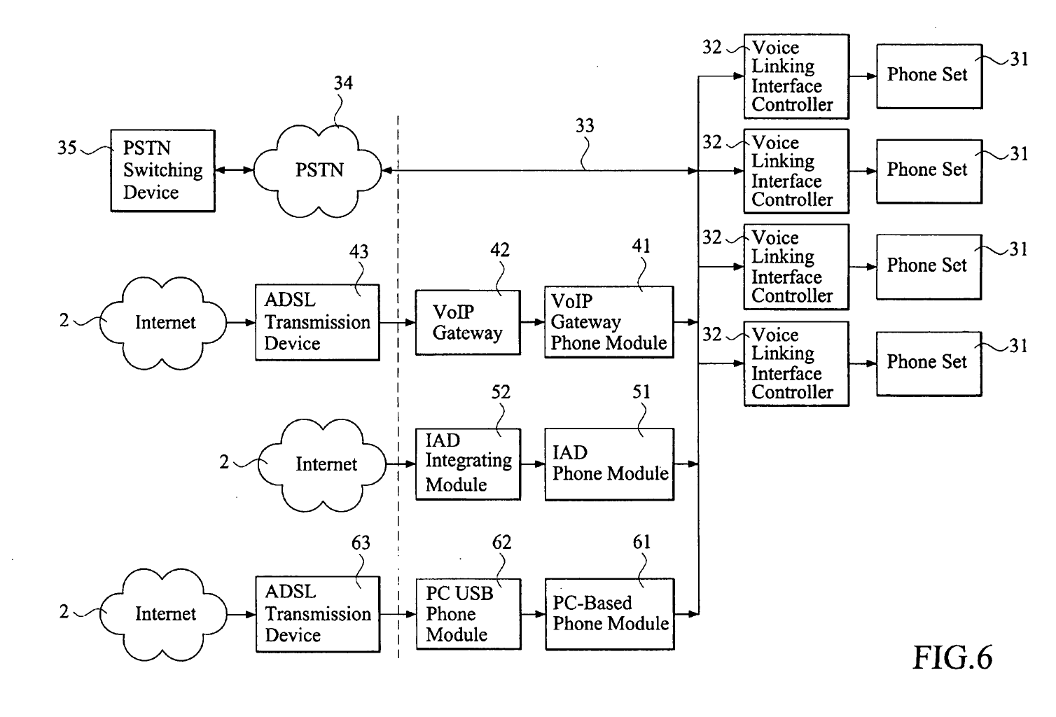

With reference to the drawings and in particular to FIG. 6, which is a block diagram of the connection between communication devices in accordance with the preferred embodiment of the present invention, conventional phone sets and various types of Network-based communication devices are connected to one single communication line by the communication system in accordance with the preferred embodiment of the present invention. The communication signals are coupled from the phone set to the network-based communication devices through the coupling devices to selectively establish a communication among the phone set and the network-based communication devices of various types.

As shown in FIG. 6, a plurality of phone sets 31 are connected to the Public Switched Telephone Network 34 and the PSTN switching device 35 by a plurality of phone control modules 32 and a telephone line 33. The telephone line 33 is also connected to a VoIP gateway phone module 41 and a VoIP gateway 42, and then connected to the Internet 2 through an ADSL transmission device 43. The telephone line 33 is further connected to an IAD phone module 51, which is connected to the Internet 2 through an IAD integrating module 52, and a PC phone module 61, which is connected to the Internet 2 through an ADSL transmission device 63, connected with a PC USB phone module 62.

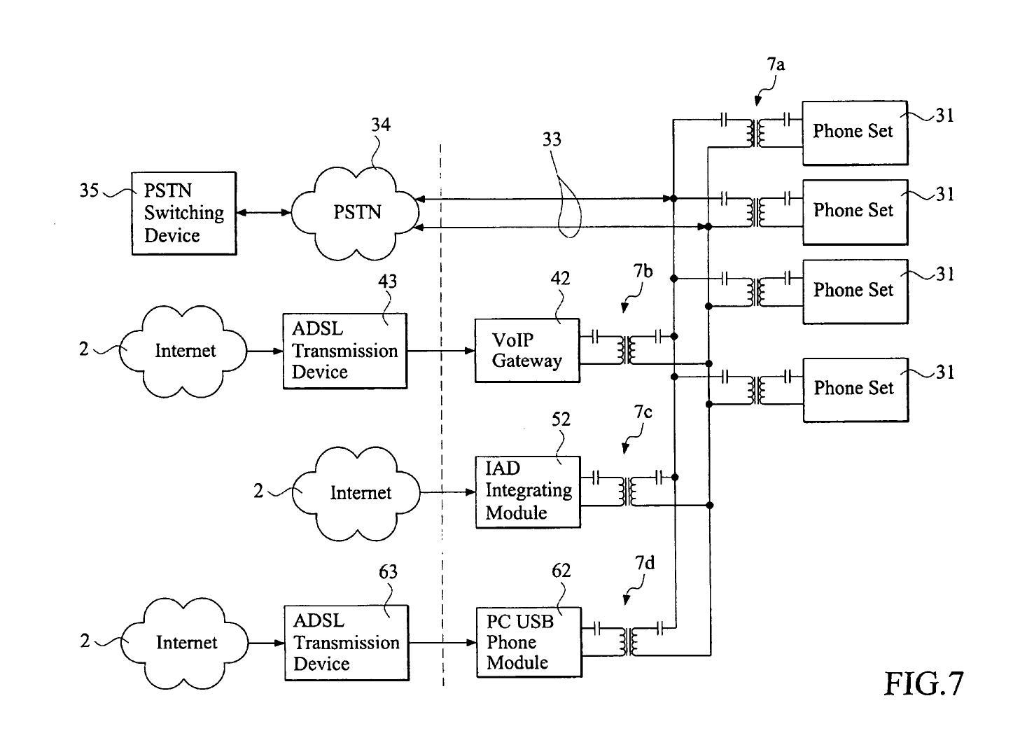

Please refer to FIG. 7 that shows the circuits of equivalent wiring between communication devices in accordance with the preferred embodiment of the present invention. As shown in the figure, since voice signals linked to a same communication line are able to communicate with each other by the transmitting of coupled signals, the circuits of equivalent wiring includes a plurality of coupling devices 7a, 7b, 7c and 7d.

The communication system in the present invention not only controls conventional phone sets to selectively communicate with various types of communication networks, but also ensures that only one phone set is communicating with one communication network at a time in order to avoid the confusing or the lost control of communications by transmitting encoded control protocols.

The control protocols of the communication system:

1. The control protocol of the dialing and receiving of the IAD/VoIP gateway phone modules:

The IAD/VoIP gateway phone modules s receive communication demands from conventional phone sets and transmit different voice signals representing different communication conditions such as detecting incoming calls, ending calls, dialing and line busy by the IAD/VoIP gateway phone modules. The central processing units of the phone modules then execute corresponding procedures after the decoding and identifying of the voice signals.

2. The control protocol of the dialing and receiving of the PC phone module:

The PC phone module receives communication demands from conventional phone sets and transmits different voice signals representing different communication conditions such as detecting incoming calls, ending calls, dialing and line busy by the PC phone modules. The central processing unit of the PC phone modules then execute corresponding procedures after the decoding and identifying of the voice signals.

The PC phone module also receives controlling codes and transfers controlling characters to the computer through a USB connection port. The PC phone software then executes corresponding procedures in accordance with received controlling characters.

3. The control protocol of the dialing and receiving of the conventional phone sets:

When the phone sets selectively establish a communication between any of the various types of communication networks, the phone sets activate PC phone modules, answer incoming calls from PC phone modules, ending calls and dialing calls by sending controlling voice signals by the conventional phone sets, sending controlling characters to PC phone modules and execute corresponding procedures in accordance with received controlling characters.

The compose of the phone modules:

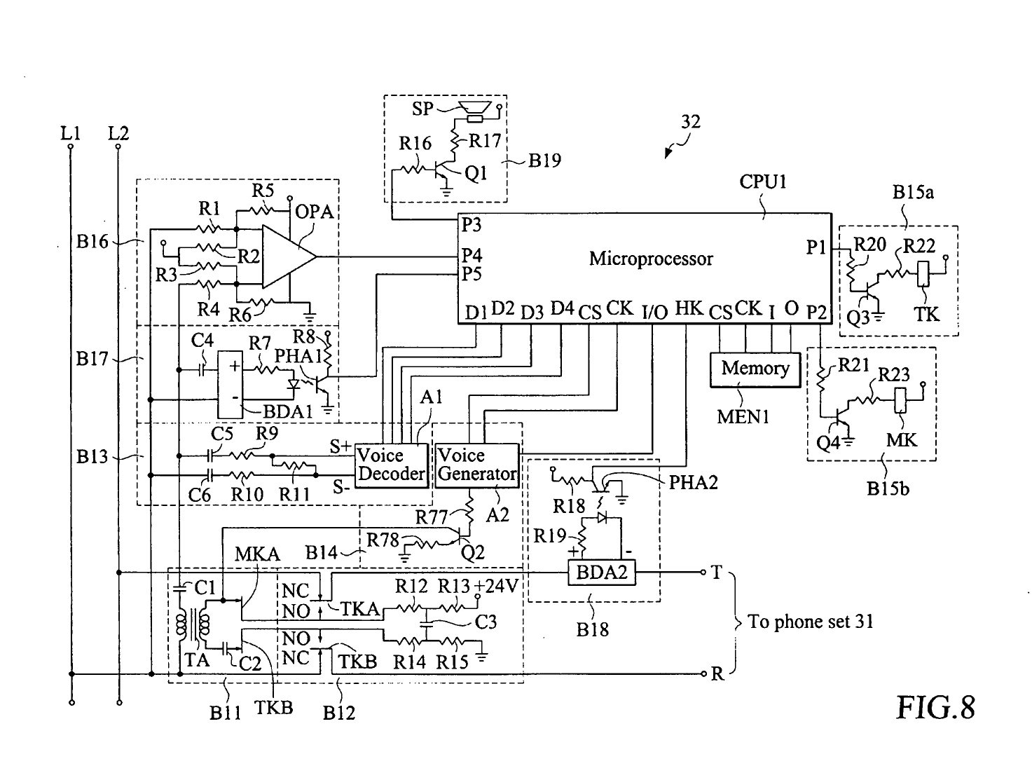

1. Conventional phone sets (as shown in FIG. 8)

(a) Communication coupling circuit B11:

The circuit B11 mainly functions as the coupling of the sound signals of the phone sets and the voice signals for controlling from conventional phone sets 31 to communication lines L1 and L2, and vice versa; hence establishes a communication and carries out the controlling. In addition, the circuit B11 also functions as the insulation of the direct currents in the phone sets and the communication lines. The communication coupling circuit B11 is the main element in establishing a communication among various types of communication networks with one communication line.

The circuit B11 is composed of a capacitor C1, communication coupling loop TA, a capacitor C2 and relay contacts MKA and MKB.

(b) Communication route transforming circuit B12:

The circuit B12 mainly functions as the transmitting of sound signals and dialing signals to the communication coupling circuit B11. The circuit B12 also supplies direct currents to phone sets 31 when the phone sets 31 established a communication with any communication network other than the cable telephone network.

The communication route transforming circuit B12 is composed of resistors R12, R13, R14 and R15, a relay contact TKA and its normal close contact NC and normal open contact NO, a relay contact TKB and its normal close contact NC and normal open contact NO and a capacitor C3.

(c) Voice decoding circuit B13:

The circuit B13 mainly function as the receiving of the controlling voice signals from the communication lines L1 and L2 and the phone sets, the decoding of the signals and the transmitting of the signals to the microprocessor CPU1 for the microprocessor CPU1 to execute corresponding procedures.

The circuit B13 is composed of a voice decoder A1, a resistor R11, R9 and R10, and capacitors C5 and C6.

(d) Voice generating circuit B14:

The circuit B14 mainly functions as the receiving of the controlling voice signals from the microprocessor CPU1 and the transferring of the signals to the communication lines L1 and L2 through the communication coupling circuit B11.

The voice generating circuit B14 is composed of a voice generator A2, resistors R77 and R78 and a transistor Q2.

(e) Busy line switching circuits B15a and B15b

The circuits B15a and B15b switch off the connection between the phone sets and the communication coupling circuit B11 when the communication lines are busy in order to prevent interferences.

The microprocessor CPU1 drives the relays TK and MK to switch off the connection, and as a result, the phone sets receive only direct currents but not capable of transferring sound signals and dialing signals to the communication coupling circuit B11.

As shown in the block of B15a, resistors R20 and R22, a transistor Q3 and a relay TK supply phone sets direct currents, and the supplying route is as follows: the resistors R13 and R12, NO contact of the relay contact TKA, phone set circuit T and R, the NO contact of the relay contact TKB, the resistors R14 and R15 and the capacitor C3.

The blocking of sound signals and dialing signals is realized by the circuit B15b as shown in the figure. The resistors R21 and R23, a transistor Q4 and the relay M drive the relay MK open, hence the sound signals and the dialing signals are unable to be transferred to the communication coupling circuit B11.

(f) Line detecting circuit B16

The circuit B16 mainly functions as the detecting of whether there is a drop in the voltage in the communication lines L1 and L2, since a drop in the voltage indicates that the communication lines are occupied by another phone set utilizing cable telephone network. As soon as the voltage drops, the circuit B16 informs the microprocessor CPU1 the drop in voltage, and the microprocessor CPU1 then executes corresponding blocking sequences to avoid interferences form other phone sets.

The circuit B16 is composed of resistors R1, R2, R3, R4, R5 and R6 and an amplifier OPA.

(g) Incoming detecting circuit B17:

The circuit B17, which is composed of a capacitor C4, resistors R7 and R8, a rectifier BDA1 and a photo coupler PHA1, functions as the detecting of the incoming ring signals from the cable telephone network and the transferring of the signals to the microprocessor CPU1.

(h) Communication detecting circuit B18

The circuit B18 functions as the detecting of whether the communication loops exist in the phone sets. If the communication loops exist in the phone set that is a calling end or a receiving end, the microprocessor CPU1 transmits corresponding controlling signals of answering calls or ending calls. On the contrary, when the communication lines are busy and the phone set connected is picked up forming a direct current loop, the microprocessor CPU1 transmits alarming tones by an audio output circuit B19.

The communication detecting circuit B18 is composed of a phone set end T, a rectifier BDA2, the NC contact of the relay TKA, the resistors R12, R13, R14 and R15, the NC contact of the relay TKB and the phone set end R.

(i) Audio output circuit B19:

The circuit B19, which is composed of resistors R16 and R17, a transistor Q1 and a speaker SP, mainly functions as the generating of audio signals under the control of the microprocessor CPU1 when incoming calls from Internet phones and PC phones exist and when the communication line is busy.

(j) Microprocessor CPU1 and memory circuit:

The microprocessor CPU1 receives signals from all circuits and executes corresponding procedures, and the memory MEN1 stores predetermined controlling character to aid the microprocessor CPU1.

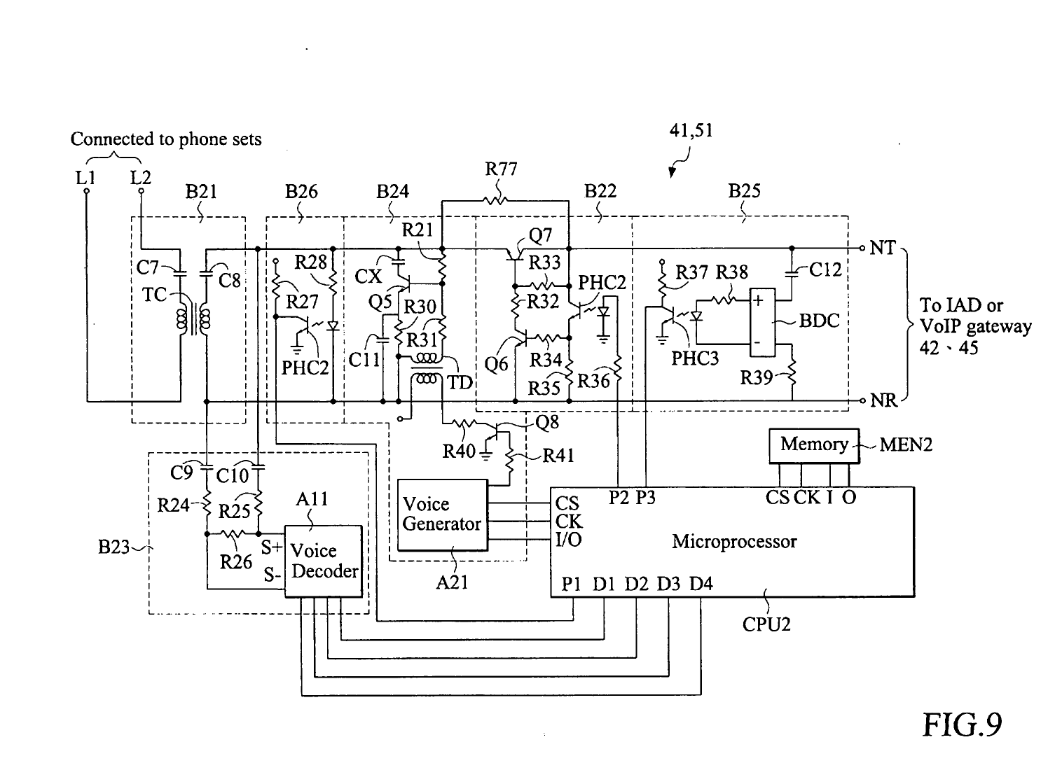

2. IAD and VoIP gateway phone modules (as shown in FIG. 9)

(a) Communication coupling circuit B21:

The circuit B21, which is composed of capacitors C7 and C8 and a coil TC, mainly function as the coupling of the sound signals of the phone modules and the voice signals for controlling from phone modules to communication lines L1 and L2, and vice versa; hence establishes a communication and carries out the controlling. In addition, the circuit B21 also functions as the insulation of the direct currents in the phone modules and the communication lines. The communication coupling circuit B21 is the main element in establishing a communication among various types of communication networks with one communication line.

(b) Communication activating circuit B22:

The circuit B22, which is composed of resistors R32, R33, R34 and R35, a photo coupler PHC2 and transistors Q6 and Q7, functions as the opening of the IAD and VoIP gateway and the communication lines L1 and L2 and the establishing of the communications. The microprocessor CPU2 drives the circuit B22 to activate the communication when the communication lines L1 and L2 request the IAD and VoIP gateway phone modules or vice versa.

(c) Voice decoding circuit B23:

The circuit B23, which is composed of a voice decoder All, resistors R24, R25 and R26 and capacitors C9 and C10, mainly function as the receiving of the controlling voice signals from the communication lines L1 and L2 and the phone modules, the decoding of the signals and the transmitting of the signals to the microprocessor CPU2 for the microprocessor CPU2 to execute corresponding procedures.

(d) Voice generating circuit B24:

The circuit B24, which is composed of a voice generator A21, resistors R40 and R41, a transistor Q2 and a coil TD, mainly functions as the receiving of the controlling voice signals from the microprocessor CPU2 and the transferring of the signals to the communication lines L1 and L2 through the communication coupling circuit B21.

(e) Incoming detecting circuit B25:

The circuit B25, which is composed of a capacitor C12, a rectifier BDC, resistors R37, R38 and R39 and a photo coupler PHC connecting the input ends NT and NR of the Internet phone module, functions as the detecting of the incoming ring signals from the IAD and VoIP gateway phone modules, the generating of signals with 20 Hz and over 45V by the input ends NT and NR of the phone modules when the IAD and VoIP phone modules send requests, and the transferring of the signals to the microprocessor CPU2.

(f) Loop detecting circuit B26:

The circuit B26, which is composed of resistors R27 and R28 and a photo coupler PHC1 connecting to the communication coupling circuit B21, functions as the making of the direct current loop when the Internet phones dial and answer and the transferring of the signals to the microprocessor CPU2.

(g) Microprocessor CPU2 and memory circuit:

The microprocessor CPU2 receives signals from all circuits and executes corresponding procedures, and the memory MEN2 stores predetermined controlling character to aid the microprocessor CPU2.

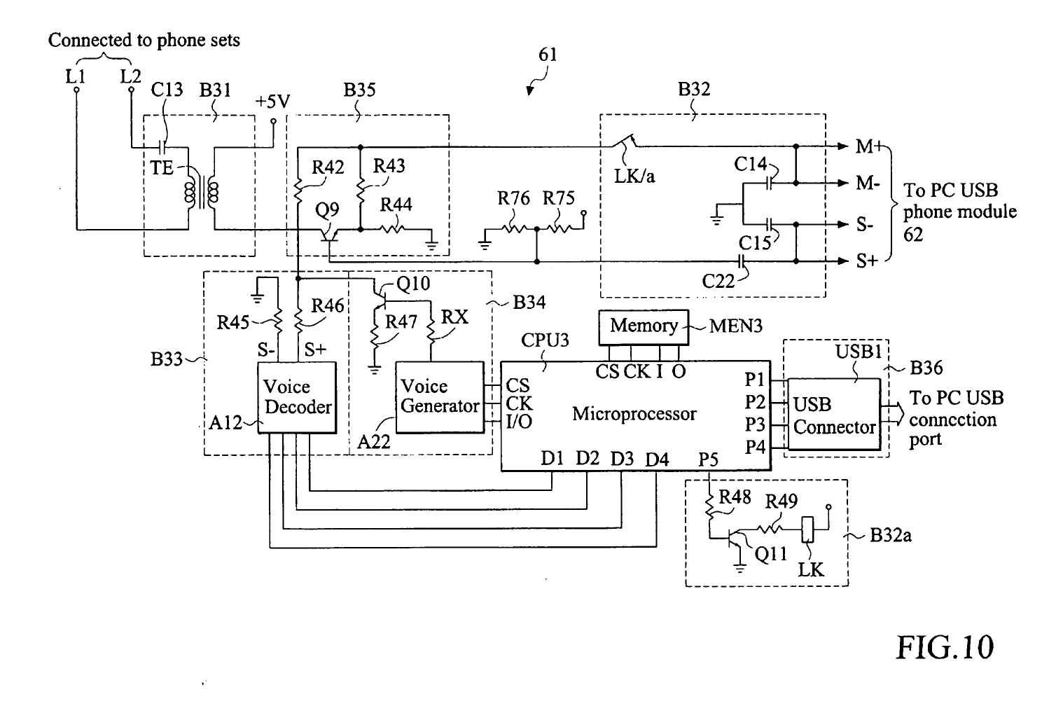

3. PC phone module (as shown in FIG. 10)

(a) Communication coupling circuit B31

The circuit B31, which is composed of a capacitor C13 and a coupling coil TE, mainly function as the coupling of the sound signals of the PC phone modules and the voice signals for controlling from phone modules to communication lines L1 and L2, and vice versa; hence establishes a communication and carries out the controlling. In addition, the circuit B31 also functions as the insulation of the direct currents in the phone modules and the communication lines. The communication coupling circuit B31 is the main element in establishing a communication among various types of communication networks with one communication line.

(b) Communication loop controlling circuit B32 and B32a:

The circuits B32 and B32a, which are composed of resistors R48 and R49, a transistor Q11 and a relay LK, function as the cutting-off of the communication of the PC phone module when the microprocessor CPU3 receives line-busy signals and drives the relay LK to block the communication of the PC phone module by opening the normal open contacts LK/a of the relay LK; hence cutting off signals transferred to the PC phone module.

(c) Voice decoding circuit B33:

The circuit B33, which is composed of a voice decoder A12 and resistors R45 and R46, mainly functions as the receiving of the controlling voice signals from the communication lines L1 and L2 and the PC phone modules, the decoding of the signals and the transferring of the signals to the microprocessor CPU3 for the microprocessor CPU3 to execute corresponding procedures.

(d) Voice generating circuit B34:

The circuit B34, which is composed of a voice generator A22, resistors R47 and RX and a transistor Q10, mainly functions as the receiving of the controlling voice signals from the microprocessor CPU3 and the transferring of the signals to the communication lines L1 and L2 through the communication coupling circuit B31.

(e) Line matching transforming circuit B35:

The circuit B35 functions as the transforming of four-wired audio signals M+, M−, S− and S+ of the four-wired communication mode of the PC into two-wired audio signals used in two-wired communication mode. The line matching transforming circuit is composed of a speaker S+, a capacitor C22, resistors R75 and R76, the base of a transistor Q9, a resistor R44, a capacitor C15 and a speaker S−. The sound signals from the phone modules are transferred to the coupling coil TE through the collector of the transistor Q9 and then coupled to the communication lines, while the sound signals from the communication lines are linked to the resistor R42, the normal open contact LK/a or the relay LK, the microphone end M+, the microphone end M− and the capacitor C14; hence establishes a two-way communication of the sound signals.

(f) USB controlling circuit B36:

The circuit B36 functions as the receiving of the controlling signals representing answering calls, dialing and ending calls and the transferring of the signals to the microprocessor CPU3, which then analyzes the signals and transfers the signals to the USB input port of the PC in the form of USB communication format through a USB connector USB1.

(g) Microprocessor CPU3 and memory circuit:

The microprocessor CPU3 receives signals from all circuits and executes corresponding procedures, and the memory MEN3 stores predetermined controlling character to aid the microprocessor CPU3.

Steps of establishing communications:

1. Conventional phone set requesting IAD/VoIP gateway phone modules:

(a) Dialing:

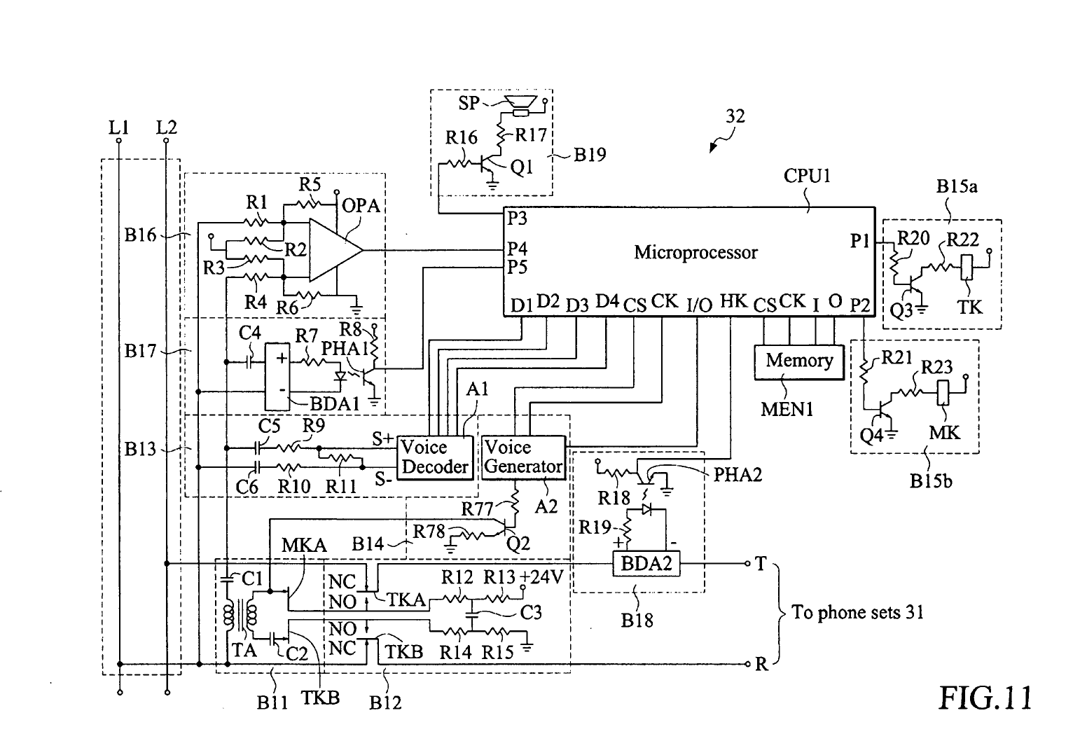

As the user picks up the phone set 31, the communication line L1, the normal close contact NC of the relay contact TKA, the rectifier BDA2, the phone circuit T and R, the normal close contact NC of the relay contact TKB and the communication line L2 forms a communication loop, and the phone set will receive dialing tones from outside connections (as shown if FIG. 11).

As the user presses a predetermined head code (a“*”for instance) on the phone set 31 representing dialing IAD/VoIP gateway phone modules, the voice decoder A1 collects the code through the communication coupling loop TA, decodes the code and transfers the code to the microprocessor CPU1 in the form of BCD codes. The microprocessor CPU1 activates the communication route transforming circuit B12 after receiving the code, and drives the relay TK to transform the direct currents of the phone set and cut down the connections between the phone set and outside connections.

The direct current power supply of the phone set is changed to a +24V power supply, which is formed with the resistors R12 and R13, the normal open contact NO of the relay contact TKA, the phone circuit T and R, the contact NO of the relay contact TKB, the resistors R14 and R15 and the ground (as shown in FIG. 11).

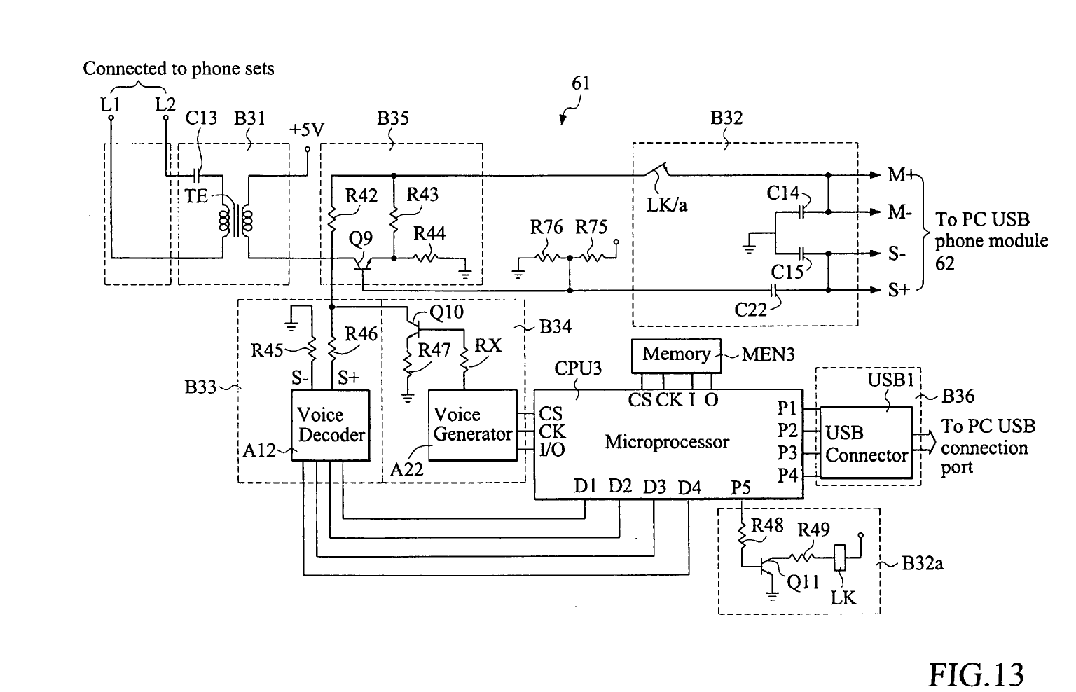

As the user presses a predetermined head code * on the main phone set, phone sets other than the main phone set and the PC phone modules shown in FIG. 13 connected to the communication lines L1 and L2 also receive the code by their own voice decoder. The code is then transferred to the microprocessor to execute a line-busy procedure in order to prevent interferences, while the PC phone modules 61 drive the communication loop controlling circuit B32 and B32a to block the Internet and other conventional phone sets.

As the code * is received and decoded by the voice decoder All of the IAD/VoIP phone modules, which are coupled to the communication lines L1 and L2 and the coil TC, it is transferred to the microprocessor CPU2. The microprocessor CPU2 then activates the communication activating circuit B22, and establishes the communication between the phone set and the IAD/VoIP phone modules.

After the user pressed the head code, the dialing numbers are coupled from the coil TA and the communication lines L1 and L2 to the coil TC of the communication coupling circuit B21 of the Internet phone modules.

As the user presses the DTMF phone codes on the phone set shown in FIG. 11, a dialing circuit is formed by the connection from the phone circuit T, the rectifier BDA2, the NO contact of TKA, the contact of MKA, a primary coil of the coil TA, the capacitor C2, the contact of MKB and the NO contact of TKB to the phone circuit R.

The primary coil of the coil TA is used to couple voice signals from secondary coils and feed the signals to the communication lines L1 and L2.

The primary coil of the coil TC of the communication coupling circuit B21 of the Internet phone modules couples the DTMF of the communication lines L1 and L2, and links to the secondary coil. The receiving of the calls is achieved by the first end of the secondary coil, the inputs NR and NT of the Internet phone modules, the collector and the emitter of the transistor Q7, the capacitor C8 and the second end of the secondary coil to the IAD/VoIP gateway.

(b) Communicating:

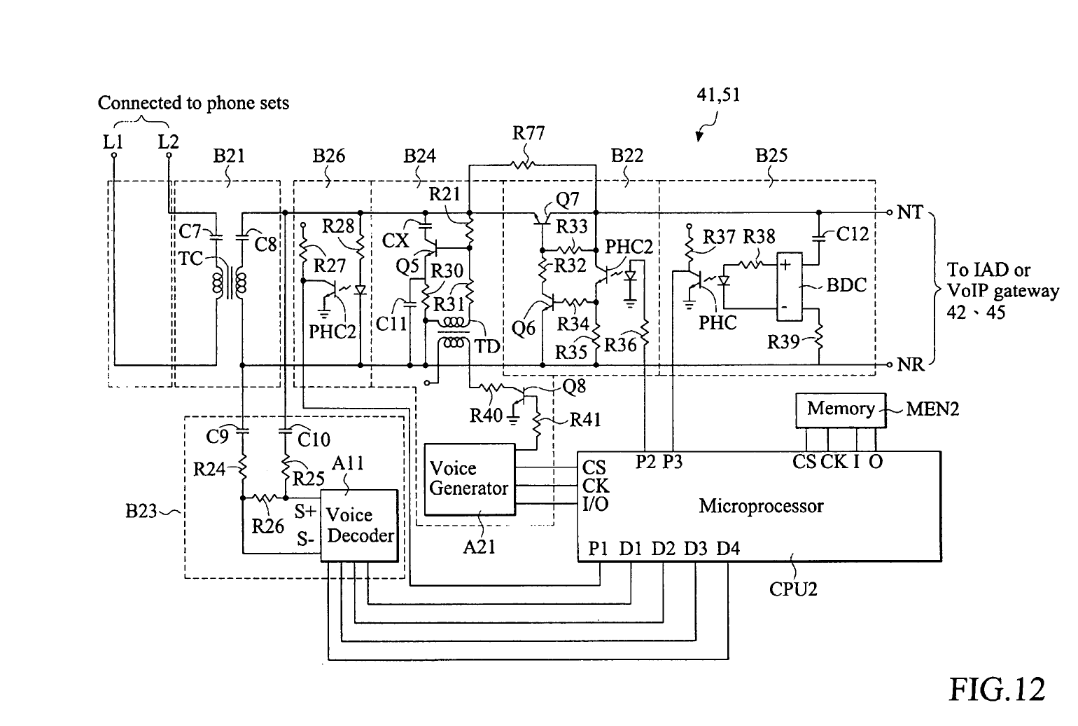

When the Internet phone modules respond to the dialer, the sound coupling route, shown in FIG. 12, is formed by feeding of the signals from the input NT of the Internet phone module, the collector and the emitter of the transistor Q7, the capacitor C8, the second end of the secondary coil of the coil TC of the communication coupling circuit B21, the first end of the secondary coil of the coil TC of the communication coupling circuit B21, the input NR of the Internet phone module and the primary coil of the coil TC of the communication coupling circuit B21 to the communication lines L1 and L2.

The coupling of the sound signals and the linking of the primary coil of the coil TA of the communication coupling circuit B11 of the conventional phone set 32 and the secondary coil through two ends of the circuit establish a communication, and the coupling route is from the first end of the secondary coil of the coil TA, the contacts of MKA, the NO contact of the relay TKA, the rectifier BDA2, the input T of the conventional phone set, phone set, the input R of the phone set, the NO contact of the relay contact TKB, the contacts of MKB, the capacitor C2 and the second end of the secondary coil of the coil TA.

(c) Ending calls:

The hanging up of the phone set of the user ends the communication between the phone set and the Internet phone module. As a consequence, the direct current circuit is cut down, and the rectifier BDA2 and the LED of the photo coupler PHA2 receives no direct currents. The microprocessor CPU1 generates ending calls controlling characters AA by the voice generator A2, and transmits the character AA to the communication lines L1 and L2. The communication route transforming circuit B12 is recovered back to the status of standing by.

All phone sets and phone modules coupled to the communication lines L1 and L2 receive ending calls controlling character AA form the coil TA, decode the character AA by the voice decoders and transfer the character to the microprocessors, and the microprocessors then recover the status of the phone sets and the phone modules back to standing by.

2. IAD/VoIP gateway phone module requests:

(a) Requesting:

When the Internet phone modules shown in FIG. 12 requests, the inputs NT and NR of the phone module generates a 20 Hz alternate current ring signal with 45V, and the ring signal is detected by the incoming detecting circuit B25 in the following sequence: the input NT of the phone module, the capacitor C12, the rectifier BDC, the resistor R38, the photo coupler PHC3, the input NR of the phone module and the collector and the emitter of the photo coupler PHC3.

The microprocessor CPU2 then transmits CC code by the voice generating circuit B24, and the code is transmitted to the communication lines L1 and L2 through the communication coupling circuit B21. The sequence is as follows: the resistor R41, the transistor Q8, the resistor R40, the primary coil of the coil TD, the secondary coil of the coil TD, the transistor Q5, the capacitor CX, the capacitor C8 and the secondary coil of the coil TC.

(b) Answering:

PC phone module 61 (as shown in FIG. 13) connected to the communication lines L1 and L2 couples incoming signals to the secondary coil of the coil TE by the communication coupling circuit B31, decodes the signals by the voice decoding circuit B33 and transfers the signals to the microprocessor CPU3. The microprocessor CPU3 then drives the drive the communication loop controlling circuit B32 and B32a to block the phone module from entering the communication.

Conventional phone set (as shown in FIG. 11) connected to the communication lines L1 and L2 is coupled to the voice decoding circuit B13 by the capacitor C5, the resistor R9, R10 and R11 and the capacitor C6, decoded and then transferred to the microprocessor CPU1, which then drives the audio output circuit B19 to generate alarming signals in order to notify the user about the incoming call.

As the user hears alarming signals representing incoming calls from the Internet phone modules and picks up the phone sets, the microprocessor CPU1 of the phone set drives the communication route transforming circuit B12, the coil TA, the rectifier BDA2, the NO contact of the relay contact TKA, the resistors R12 and R13, the +24V, the ground, the resistors R15 and R14 and the NO contact of the relay contact TKB to form a direct current loop. The photo coupler PHA is connected so that the resistor R18 transforms into ground, and the microprocessor transmits DD answering code to the communication lines L1 and L2 by the generating of the code of the voice generator A1 and the coupling of the communication coupling circuit B11.

The voice decoding circuit B23 of the Internet phone module couples the answering code DD through the communication coupling circuit B21, decodes the code and then transfers the code to the microprocessor CPU2, which then drives the communication activating circuit B22 to establish a communication between the conventional phone set and the IAD/VoIP gateway phone module.

(c) Ending calls:

The hanging up of the phone set of the user ends the communication between the phone set and the Internet phone module. As a consequence, the direct current circuit is cut down, and the rectifier BDA2 and the LED of the photo coupler PHA2 receives no direct currents. The microprocessor CPU1 generates ending calls controlling characters AA by the voice generator A2, and transmits the character AA to the communication lines L1 and L2. The communication route transforming circuit B12 is recovered back to the status of standing by.

All phone sets and phone modules coupled to the communication lines L1 and L2 receive ending calls controlling character AA form the coil TA, decode the character AA by the voice decoders and transfer the character to the microprocessors, and the microprocessors then recover the status of the phone sets and the phone modules back to standing by.

3. Conventional phone set requesting PC phone module:

As the user picks up the phone set 31, the communication line L1, the normal close contact NC of the relay contact TKA, the rectifier BDA2, the phone circuit T and R, the normal close contact NC of the relay contact TKB and the communication line L2 forms a communication loop, and the phone set will receive dialing tones from outside connections (as shown if FIG. 11).

As the user presses a predetermined head code (a “#” for instance) on the phone set 31 representing dialing PC phone modules, the voice decoder Al collects the code through the communication coupling loop TA, decodes the code and transfers the code to the microprocessor CPU1 in the form of BCD codes. The microprocessor CPU1 activates the communication route transforming circuit B12 after receiving the code, and drives the relay TK to transform the direct currents of the phone set and cut down the connections between the phone set and outside connections.

The direct current power supply of the phone set is changed to a +24V power supply, which is formed with the resistors R12 and R13, the normal open contact NO of the relay contact TKA, the phone circuit T and R, the contact NO of the relay contact TKB, the resistors R14 and R15 and the ground (as shown in FIG. 11).

As the user presses a predetermined head code # on the main phone set, phone sets other than the main phone set and the IAD/VoIP phone modules shown in FIG. 12 connected to the communication lines L1 and L2 also receive the code by their own voice decoder. The code is then transferred to the microprocessor to execute a line-busy procedure in order to prevent interferences, while the IAD/VoIP phone modules ignores incoming calls from the Internet to prevent interferences, and other conventional phone sets drive the communication route transforming circuit B12 to block phone sets.

As the code # is received and decoded by the voice decoder A12 of the PC phone modules, which are coupled to the coil TE of the communication lines L1 and L2, it is transferred to the microprocessor CPU3. The microprocessor CPU3 then activates the communication loop controlling circuit, and establishes the communication between the phone set and the PC phone modules.

After the user pressed the head code, the dialing numbers are coupled from the communication coupling circuit and the communication lines L1 and L2 to the communication coupling circuit B21 of the PC phone modules.

As the user presses the DTMF phone codes on the phone set shown in FIG. 11, a dialing circuit is formed by the connection from the phone circuit T, the rectifier BDA2, the NO contact of TKA, the contact of MKA, a primary coil of the coil TA, the capacitor C2, the contact of MKB and the NO contact of TKB to the phone circuit R.

The primary coil of the coil TE of the communication coupling circuit B21 of the PC phone modules couples the DTMF code of the communication lines L1 and L2, links to the secondary coil, decodes the code with the voice decoder A12, and transfers the code to the microprocessor CPU3. The receiving of the calls is achieved by the transmitting of the code of the microprocessor CPU3 to the PC through the USB connection port.

(a) Communicating

When the PC phone modules respond to the dialer, the sound coupling route, shown in FIG. 12, is formed by the changing of the current of the S+ input, the capacitor C22, the transistor Q9, the resistor R44, the capacitor C15, the S− input and the base of the transistor Q9 due to the responding. The secondary coil of the coil TE couples the change of the current to the communication lines L1 and L2 through the primary coil.

The secondary coil of the coil TE of the PC phone module couples the sound signals from the primary coil, and transmits the sound signals to the microphone of the PC from the +5V, the secondary coil of the coil TE, the resistor R42, the LK/a contact of the relay LK, the M+, the M−, the capacitor C14 and the ground.

The four-wired communication of the PC phone module is transformed to the two-wired communication of the conventional phone set through the input/output and matching of the transistor Q9, hence establishes a communication.

The coupling of the sound signals and the linking of the primary coil of the coil TA of the communication coupling circuit B11 of the conventional phone set 32 and the secondary coil through two ends of the circuit establish a communication, and the coupling route is from the secondary coil of the coil TA, the contacts of MKA, the NO contact of the relay TKA, the rectifier BDA2, the inputs T and R of the conventional phone set, the NO contact of the relay contact TKB, the contacts of MKB, the capacitor C2 and another secondary coil of the communication coupling circuit B11.

(c) Ending calls:

The hanging up of the phone set of the user ends the communication between the phone set and the PC phone module. As a consequence, the direct current circuit is cut down, and the rectifier BDA2 and the LED of the photo coupler PHA2 receives no direct currents. The microprocessor CPU1 generates ending calls controlling characters AA by the voice generator A1, and transmits the character AA to the communication lines L1 and L2. The communication route transforming circuit B11 is recovered back to the status of standing by.

The PC phone module couples the ending call controlling character AA to the secondary coil of the coil TE of the communication lines L1 and L2 through the primary coil of the coil TE of the communication coupling circuit B31, decodes the characters AA by the voice decoding circuit B33 and transfers the characters to the microprocessor CPU3. The microprocessor CPU3 then transmits the characters AA to the PC through the USB connection port in order to end calls.

All phone sets and phone modules coupled to the communication lines L1 and L2 receive ending calls controlling character AA form the coil TA, decode the character AA by the voice decoders and transfer the character to the microprocessors, and the microprocessors then recover the status of the phone sets and the phone modules back to standing by.

4. PC phone module requests:

(a) Requesting:

When the PC phone module shown in FIG. 13 requests, the transistor Q9 receives incoming code CC from the speaker end S+. The voice decoding circuit B33 then decodes the code and notifies the microprocessor CPU3 about the incoming call.

The microprocessor CPU3 transmits the code CC to the communication lines L1 and L2 by the voice generating circuit B34 through the communication coupling circuit B31, the resistor R75, the transistor Q9, the secondary coil of the coil TE, the +5V and the primary coil of the coil TE.

(b) Answering:

PC phone module (as shown in FIG. 13) connected to the communication lines L1 and L2 couples incoming signals to the secondary coil of the coil TC by the communication coupling circuit B21, decodes the signals by the voice decoding circuit B23 and transfers the signals to the microprocessor CPU2. The microprocessor CPU2 then drives the drive the communication loop controlling circuit B22 to block the phone module from entering the communication.

Conventional phone set (as shown in FIG. 11) connected to the communication lines L1 and L2 is coupled to the voice decoding circuit B13 by the capacitor C5, the resistor R9, R10 and R11 and the capacitor C6, decoded and then transferred to the microprocessor CPU1, which then drives the audio output circuit B19 to generate alarming signals in order to notify the user about the incoming call.

As the user hears alarming signals representing incoming calls from the PC phone modules and picks up the phone sets, the microprocessor CPU1 of the phone set drives the communication route transforming circuit B12, the coil TA, the rectifier BDA2, the NO contact of the relay contact TKA, the resistors R12 and R13, the +24V, the ground, the resistors R15 and R14 and the NO contact of the relay contact TKB to form a direct current loop. The photo coupler PHA is connected so that the resistor R18 transforms into ground, and the microprocessor transmits DD answering code to the communication lines L1 and L2 by the generating of the code of the voice generator A1 and the coupling of the communication coupling circuit B11.

The voice decoding circuit B33 of the PC phone module couples the answering code DD through the communication coupling circuit B31, decodes the code and then transfers the code to the microprocessor CPU3, which then drives the communication activating circuit B32 to establish a communication between the conventional phone set and the PC phone module.

(c) Ending calls:

The hanging up of the phone set of the user ends the communication between the phone set and the PC phone module. As a consequence, the direct current circuit is cut down, and the rectifier BDA2 and the LED of the photo coupler PHA2 receives no direct currents. The microprocessor CPU1 generates ending calls controlling characters AA by the voice generator A2, and transmits the character AA to the communication lines L1 and L2. The communication route transforming circuit B12 is recovered back to the status of standing by.

5. Conventional phone set requesting conventional phone set:

(a) Dialing:

As the user picks up the phone set 31, the communication line L2, the normal close contact NC of the relay contact TKA, the rectifier BDA2, the phone circuit T and R, the normal close contact NC of the relay contact TKB and the communication line L1 forms a communication loop, and the phone set will receive dialing tones from outside connections (as shown if FIG. 11).

As the user presses a predetermined head code other than a “#” or a “*” on the phone set 31, the voice decoding circuit B13 collects the code through the primary coil of the coil TA, decodes the code and transfers the code to the microprocessor CPU1 in the form of BCD codes. The microprocessor CPU1 activates the dialing to the cable telephone and establishing a communication after the receiving of the codes.

When the phone set occupies the communication lines to establish a communication between the conventional phone sets, the voltage of the direct current of the communication lines L1 and L2 is dropped from 48V to less than 30V. The line detecting circuit B16 of the phone sets beside the one in communication detects the occupying status and notifies the microprocessor CPU1 to activate the communication route transforming circuit B12 in order to prevent phone sets from interfering the communication.

(b) Communicating:

The user dials the numbers by the communication loop formed from the communication line L2, the NC contact of the TKA, the rectifier BDA2, the phone circuit T and R and the NC contact of the relay TK to the communication line L1. The communication is established after the call is being answered.

(c) Ending calls:

The hanging up of the phone set of the user ends the communication. As a consequence, the direct current circuit is cut down, and the rectifier BDA2 and the LED of the photo coupler PHA2 receives no direct currents. The microprocessor CPU1 generates ending calls controlling characters AA by the voice generator A2, and transmits the character AA to the communication lines L1 and L2. The communication route transforming circuit B11 is recovered back to the status of standing by.

All phone sets and phone modules coupled to the communication lines L1 and L2 receive ending calls controlling character AA form the coil TA, decode the character AA by the voice decoders and transfer the character to the microprocessors, and the microprocessors then recover the status of the phone sets and the phone modules back to standing by.

The direct current loop is cut down as the user hangs up the phone set, and the voltage of the direct current of the communication lines L1 and L2 rises back to 48V. The line detecting circuit B16 of the phone sets beside the one in communication detects the status and notifies the microprocessor CPU1 to release the communication route transforming circuit B12 in order to have the phone set return to the status of standing by.

6. Conventional phone set requests:

(a) Requesting:

When the phone set shown in FIG. 11 requests, the communication lines L1 and L2 receives a 20 Hz alternate current ring signal with a voltage of 45V, and the ring signals is generated from the communication line L2, the NC contact of the relay contact TKA, the rectifier BDA2, the input T, the phone circuit, the input R, the NC contact of the relay contact TKB and the communication line L1.

(b) Answering:

As the user hears the alarming rings and picks up any phone set, the communication line L1, the normal close contact NC of the relay contact TKA, the rectifier BDA2, the phone circuit T and R, the normal close contact NC of the relay TK and the communication line L2 forms a communication loop.

When the phone set occupies the communication lines to establish a communication between the conventional phone sets, the voltage of the direct current of the communication lines L1 and L2 is dropped from 48V to less than 30V. The line detecting circuit B16 of the phone sets beside the one in communication detects the occupying status and notifies the microprocessor CPU1 to activate the communication route transforming circuit B12 in order to prevent phone sets from interfering the communication.

(c) Ending calls:

The hanging up of the phone set of the user ends the communication between the phone set and the PC phone module. As a consequence, the direct current circuit is cut down, and the rectifier BDA2 and the LED of the photo coupler PHA2 receives no direct currents. The microprocessor CPU1 generates ending calls controlling characters AA by the voice generator A2, and transmits the character AA to the communication lines L1 and L2. The communication route transforming circuit B12 is recovered back to the status of standing by.

All phone sets and phone modules coupled to the communication lines L1 and L2 receive ending calls controlling character AA form the coil TA, decode the character AA by the voice decoders and transfer the character to the microprocessors, and the microprocessors then recover the status of the phone sets and the phone modules back to standing by.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. A communication system, comprising:
a communication line for transmitting communication signals;
at least one phone set connected to a Public Switched Telephone Network and a PSTN switching device through the communication line;
a plurality of coupling devices of various types connected to the communication line; and
a plurality of network-based communication devices of various types, each of the network-based communication devices being connected to the communication line through a coupling device and connected to an Internet through a network transmission device;
wherein the communication signals are coupled from the phone set to the network-based communication devices through the coupling devices to selectively establish a communication among the phone sets and the network-based communication devices.

2. The communication system as claimed in claim 1, wherein the network-based communication device comprises a VoIP gateway phone module and a VoIP gateway, and connected to the Internet through an ADSL transmission device.

3. The communication system as claimed in claim 1, wherein the network-based communication device comprises an IAD phone module and an IAD integrating module, and connected to the Internet.

4. The communication system as claimed in claim 1, wherein the network-based communication device comprises a computer phone module, and connected to the Internet through an ADSL transmission device.

5. The communication system as claimed in claim 4, wherein the computer phone module is a four-wired communication device.

6. The communication system as claimed in claim 1, wherein the communication signals comprise communication controlling signals including incoming calls, ending calls and dialing of the phone set and the network-based communication devices, and each of the communication controlling signals comprises a predetermined voice signal of different types.

7. The communication system as claimed in claim 1, wherein the communication system further comprises a box for accommodating the coupling devices and the communication line.

8. The communication system as claimed in claim 1, wherein the communication system is built-in one of a traditional phone set, a wireless phone set, a computer sound effect module, an ADSL transmission device, an IAD integrating device and a VoIP gateway.
